(19) United States
(12) Patent Application Publication
(10) Pub. No.: US 2008/0314326 A1
(43) Pub. Date: Dec. 25, 2008

(54) Disposable, portable container for pet food or water

(76) Inventor: Karen L. Albert, Malibu, CA (US)

Correspondence Address: MORRISS OBRYANT COMPAGNI, P.C., 734 EAST 200 SOUTH, SALT LAKE CITY, UT, 84102, US

(21) Appl. No.: 12/154,850

(22) Filed: May 27, 2008

Related U.S. Application Data
(60) Provisional application No. 60/931,769, filed on May 25, 2007.

(51) Int. Cl. A01K 5/00; A47G 19/02; B65D 25/28

(52) U.S. Cl. 119/61.56; 220/574; 220/752

(57) ABSTRACT

A portable, disposable, lightweight container is provided for carrying and storing pet food and water in a manner that enables a pet owner to prepare or purchase prepackaged water or food for a pet, and then provide the food or water to a pet or companion animal when away from the normal place of feeding the animal, such as when traveling. The container is sized with an opening sufficient to receive the muzzle, snout or beak of the animal, and includes a lid and means for carrying and stacking the container.

### CROSS-REFERENCE TO RELATED APPLICATION

This application claiming priority to provisional patent application Ser. No. 60/931,769 filed May 25, 2007.

### BACKGROUND OF THE INVENTION

1. Field of the Invention

This invention relates to devices for providing water or food for pet consumption. This invention specifically relates to a disposable and portable device for providing water or food to a pet outside or away from the home or normal place of feeding.

2. Description of Related Art

Pets, particularly dogs and cats, are conventionally fed at home by means of bowls that are placed on the floor or ground so as to be accessible by the pet. A bowl is provided for water and a separate bowl in provided for food. The bowls are typically made of heavier-weight materials in order to ensure that the bowls either stay in place or are not significantly moved by the pet during feeding. Thus, such feeding devices are highly suitable for providing food and water to pets at home or in the usual place where the pets are kept and cared for.

However, many people these days travel frequently with their pets, or take their pets for extended walks or hikes. During traveling episodes, it becomes necessary to provide water to the pet on a regular basis, and for extended excursions, it may even be necessary to provide food for the animal.

At present, pet owners will carry a conventional water or food bowl with them during traveling to provide their pets with water and food. They carry the water in a separate bottle, usually of the plastic type used by humans to carry water. Food is usually carried in a separate bag, if the food is dry, or is carried in a can or a plastic container of the type used for human food if the food is wet.

The multiple containers that are carried and used by pet owners to provide water and food to their pets when outside of the home presents significant burdens. First, the many water and food containers are difficult to carry and/or pack. Second, the containers are not necessarily suitably designed for use by animals, but are more suited to use by humans. Third, the need to transport heavy and numerous containers, which must then be re-packed or stored away for further transport, is terribly inconvenient.

Thus, it would be an improvement in the pet care industry to provide disposable, easily transportable containers for watering and feeding pets that are designed and shaped for accommodating animals, which are designed for stable positioning on a floor or other supporting surface, and which are recyclable.

### BRIEF SUMMARY OF THE INVENTION

In accordance with the present invention, a lightweight, disposable, portable, recyclable container for pet food and water is provided which is sized and designed for use by cats, dogs and any other number and type of animal that may be considered a pet or companion. The container is easily stored, stacked, sealable and transportable for use in any place or environment outside the animal's normal abode or place of feeding.

The container of the present invention is generally configured with a closed bottom, an open top and an upstanding continuous side wall extending between the bottom and top. The open top is sized in diameter to comfortably receive the muzzle, snout or beak of an animal so that the animal can retrieve food or water from the container. In a particularly preferred embodiment, the diameter of circumference of the bottom may be greater than the diameter or circumference of the top.

The top of the container is configured to retain a lid so that the container may be sealed to retain food or water within the container. The structure and configuration of the top may vary in any manner to enable the attachment of a lid. For example, the top may be configured with a lip to receive and retain a snap-on lid. Alternatively, the top may be structured with a thread to enable a similarly threaded lid to be screwed onto the container. The lid may be tethered or otherwise connected to the container in a manner that will avoid permanent separation and potential loss of the lid, and thereby enable amounts of unconsumed water or food to be stored in the container.

The container of the present invention may also preferably be configured with at least one handle. The size, shape, dimension and placement of the handle or handles on the container may vary. The handles enable the container to be easily handled, manipulated, carried and stored.

The container of the present invention may be configured to enable the containers to be stacked one atop another to facilitate storage and packing, such as into a backpack or cooler. These and other features of the invention are described and illustrated more fully in the detailed description.

### BRIEF DESCRIPTION OF THE SEVERAL VIEWS OF THE DRAWINGS

In the drawings, which illustrate was is currently considered to be the best mode for carrying out the invention:

FIG. 1A is a perspective view of a first embodiment of the container of the present invention;

FIG. 1B is a side view in elevation of the embodiment shown in FIG. 1A, turned to illustrate the placement of the handles;

FIG. 1C is a plan view of the container embodiment shown in FIG. 1A;

FIG. 1D is a side view in elevation of the embodiment shown in FIG. 1B, rotated 90°;

FIG. 2A is a perspective view of an alternative embodiment of the container depicting an alternative handle design, and having two handles;

FIG. 2B is a side view in elevation of the embodiment of the invention shown in FIG. 2A;

FIG. 3A is a perspective view of another alternative embodiment of the container depicting another alternative handle design, and having a single handle;

FIG. 3B is a side view in elevation of the embodiment of the invention shown in FIG. 3A;

FIG. 4A is a perspective view of stacked containers of the embodiment shown in FIGS. 2A and 2B;

FIG. 4B is a side view in elevation of the stacked containers shown in FIG. 4A;

FIG. 5A is a perspective view of stacked containers of the embodiment shown in FIGS. 3A and 3B;

FIG. 5B is a side view in elevation of the stacked containers shown in FIG. 5A;

FIG. 6A is a perspective view of the container shown in FIG. 2A with an associated lid that is no positioned on the container;

FIG. 6B is a perspective view of an alternative embodiment of the container of FIG. 6A with the lid attached and tethered to the container;

FIG. 7A is a perspective view of another embodiment of the container of the present invention having a threaded neck;

FIG. 7B is a side view in elevation of the embodiment shown in FIG. 7A, turned to illustrate the placement of the handles;

FIG. 7C is a plan view of the container embodiment shown in FIG. 7A;

FIG. 7D is a side view in elevation of the embodiment shown in FIG. 7B, rotated 90°;

FIG. 8A is a perspective view of the embodiment of the container shown in FIGS. 7A-7D, with the lid attached;

FIG. 8B is a side view in elevation of the embodiment shown in FIG. 8A;

FIG. 8C is a plan view of the container embodiment shown in FIG. 8A;

FIG. 8D is a side view in elevation of the embodiment shown in FIG. 8B, rotated 90°;

FIG. 8E is a view of the bottom of the container shown in FIG. 1A, FIG. 7A and FIG. 8A illustrating the configuration of the bottom;

FIG. 9A is a side view in elevation of another embodiment of the invention illustrating an alternative design of the handles;

FIG. 9B is a side view of the container shown in FIG. 9A rotated 90°; and

FIG. 9C is a plan view of the container shown in FIG. 9A.

### DETAILED DESCRIPTION OF THE INVENTION

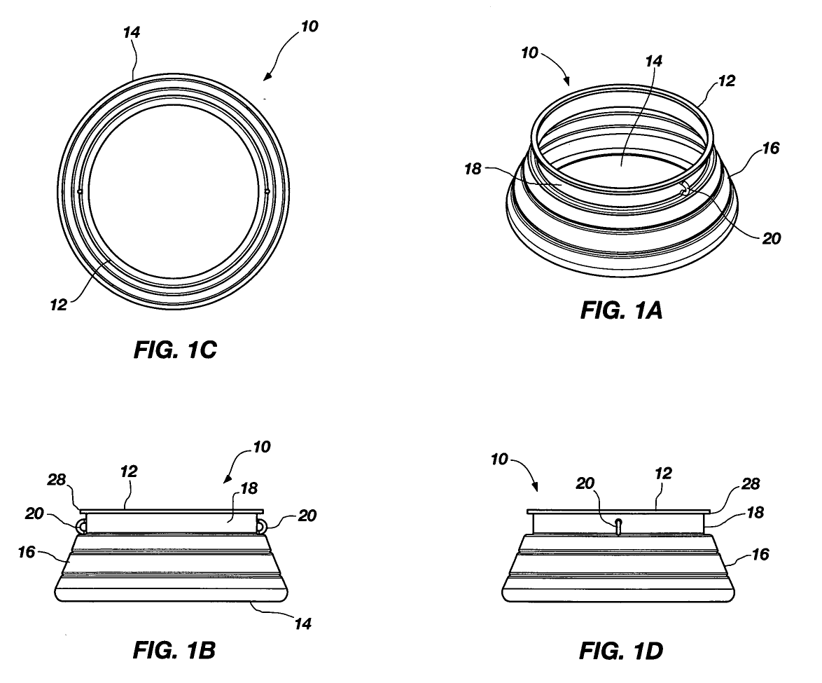

A first embodiment of the container 10 of the present invention is shown in FIGS. 1A-1D, which also illustrate the general elements of the container 10. The container 10 generally comprises a receptacle having an open top 12, a closed bottom 14 and an upstanding, continuous wall 16 that extends between the top 12 and bottom 14.

The container 10 is generally a bowl-shaped device and may be made of any appropriate material that renders the container 10 portable and disposable, and preferably recyclable. Notably, while the container 10 may be disposable, the container 10 may also be made to be reusable. Consequently, a particularly suitable material for making the container 10 is a recyclable plastic or recycled fibrous material that is biodegradable.

To render the container easily transportable, it is desirable that the container be made of lightweight material. The container 10 may have a weight ranging from less than one ounce to approximately twelve ounces, although larger containers sized to accommodate larger animals may weigh more than one pound.

The open top 12 of the container 10 is sized and shaped for accommodating the muzzle, snout or beak of an animal. Such animals may include, but are not limited to, dogs, cats, horses, pigs, birds, rodents, and any other animal that may be considered a pet or a companion by its owner. Thus, the diameter of the open top 12 may range in size from about two inches to in excess of sixteen inches (in the case of horses), and the circumferential dimension of the open top 12 may range from about six inches to greater than forty inches.

In a particularly suitable embodiment as shown, the diameter/circumference of the bottom 14 may be greater than the diameter/circumference of the open top 12 to provide a more substantial contact surface of the container 10 and to provide greater capacity for food or water. The upstanding wall 16 may, therefore, slope at an angle from the open top 12 to the closed bottom 14 as shown. However, the container 10 may be configured with other suitable shapes, dimensions and/or sizes.

The container 10 may, as in the embodiment shown in FIGS. 1A-1D, be formed with an upstanding neck portion 18 that extends from the continuous side 16 to the open top 12. In this embodiment, the upstanding neck portion 18 may be provided, or formed, with one or more handles 20. The container 10 of the present invention is generally structured or provided with at least one handle that enables the container 10 to be hooked or otherwise attached, such as by a strap or lanyard, to a belt, backpack, or other supporting member for ease of transport and carrying.

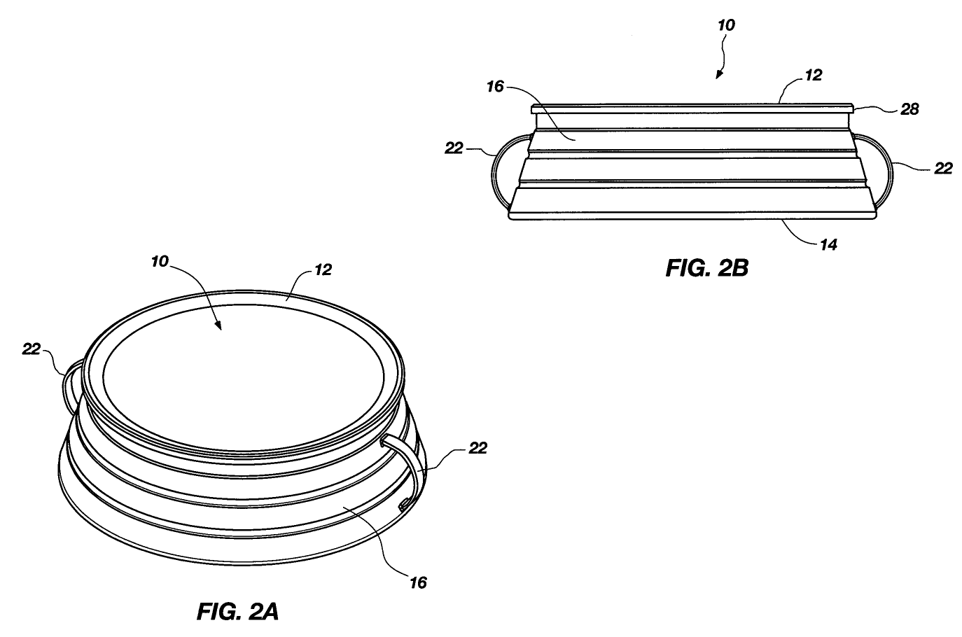

As shown in FIGS. 2A and 2B, in an alternative embodiment of the container 10, one or more handles 22 may be formed integrally with the continuous side 16 of the container 10. FIGS. 2A and 2B illustrate one shape of a handle 22 which is generally hemispherical.

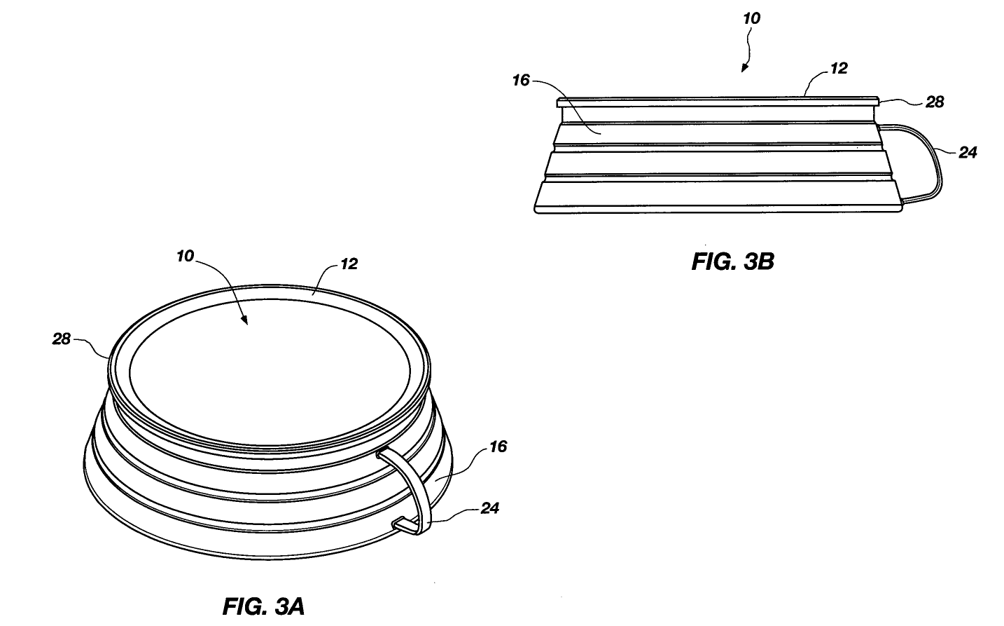

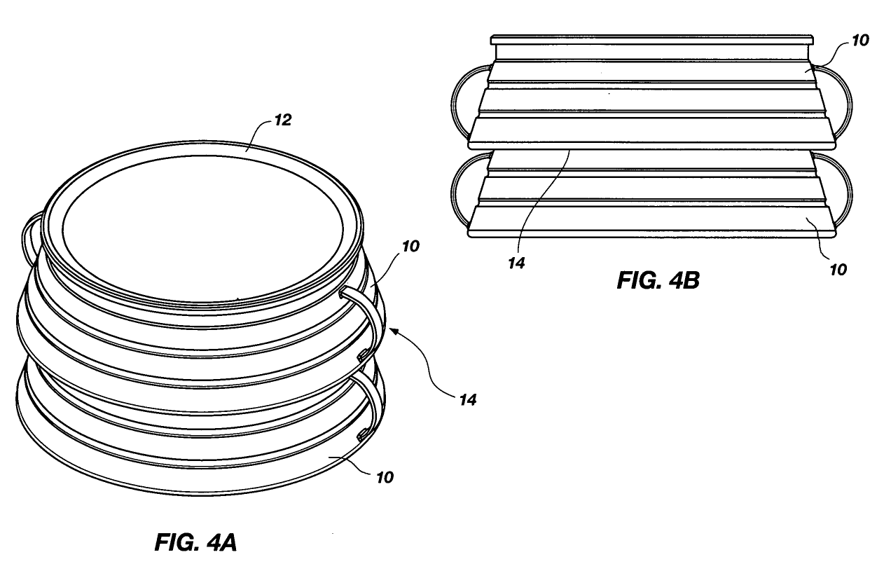

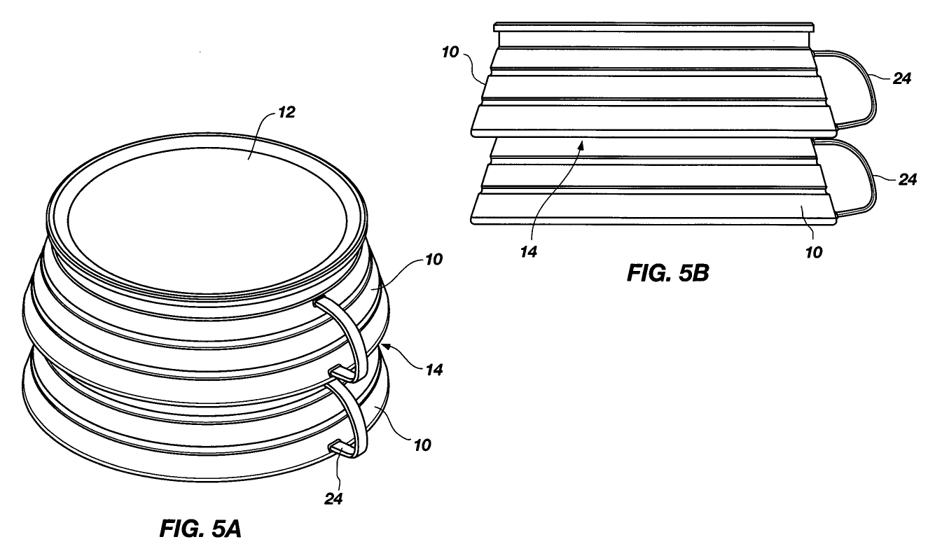

FIGS. 3A and 3B show an alternative embodiment where the handles 24 are D-shaped. The shape of the handles may vary considerably and are not limited in shape or configuration to those shapes illustrated herein. It is also to be noted that the container 10 need not be formed with handles at all. Alternatively, a plurality of handles may be formed with or on the container 10. It is only optionally desirable that the shape, size or dimension of the handles should be such that the handles do not interfere with the ability to stack multiple containers 10 one upon another, as illustrated in FIGS. 4 and 5, where like elements of the invention are denoted with like reference numerals.

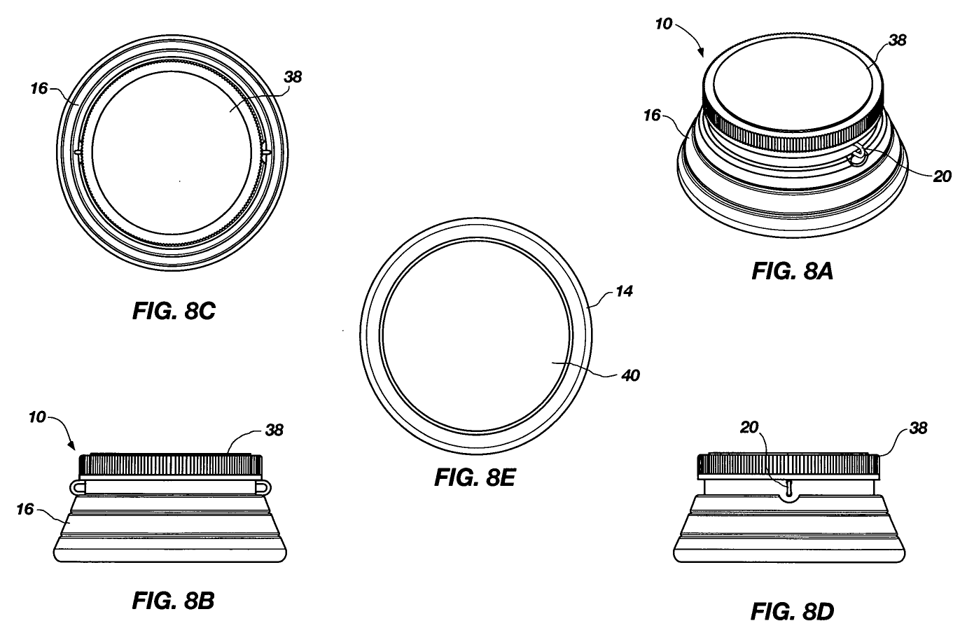

The ability to stack two or more containers 10 one upon the other, as illustrated in FIGS. 4 and 5, may be facilitated by the bottom 14 of the container 10 being configured with an indentation 40, as shown in FIG. 8E, which extends inwardly from the bottom 14 of the container 10 toward the top 12, the shape and/or diameter of the indentation 40 being congruent and compatible with the size, dimension and/or shape of the top 12 of the container 10 or the lid to enable the indentation 40 to register with, rest upon or nest on the open top 12 or lid of the container 10 upon which it is stacked.

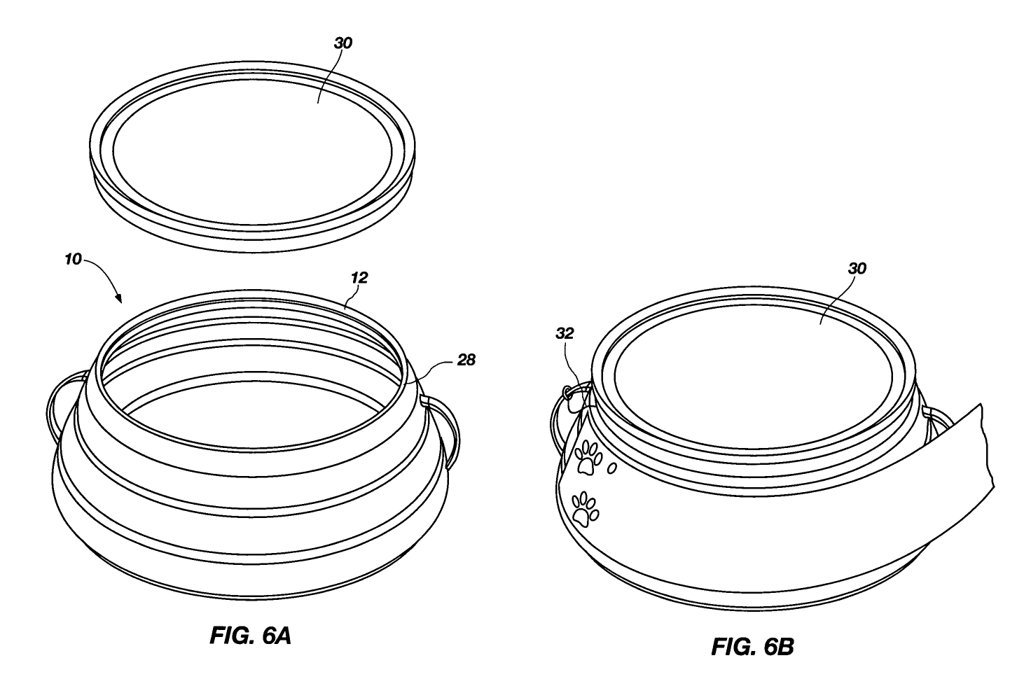

The open top 12 of the container 10 is generally configured to retain a closure or lid of some type to enable the open top 12 to be closed. Thus, in the embodiment shown in FIGS. 1A-1D, a lip 28 may be formed at or near the top 12 to enable the attachment of a lid 30, as further illustrated in FIGS. 6A and 6B. The lid 30 may be configured in a known manner to snap onto the lip 28 of the container 10 to provide a comprehensive and sealing engagement between the lid 30 and the container 10. The lid 30 may be tethered to the container 10 in some manner, as shown in FIG. 6B, to ensure that the lid does not become separated from the container 10.

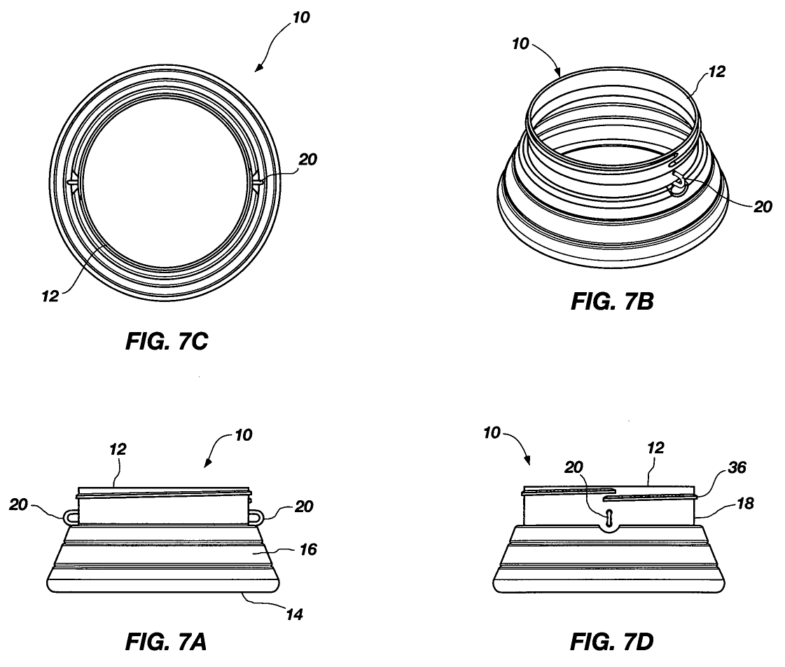

Alternatively, as shown in FIGS. 7A-7D and FIGS. 8A-8E, the open top 12 of the container may be structured with a thread 36 to threadingly receive a similarly threaded lid 38. The ability to close the open top 12 provides the advantage of being able to enclose unused portions of food or water within the container 10 until such time as the animal requires further feeding or watering.

Further, the ability to seal the open top 12 enables the container 10 to be pre-filled with either water or food and sold in a pre-filled form for the convenience of consumer purchase and transport. The pet owner does not then need to fill the container, and can simply buy the necessary water or food, pre-packaged in the container of the present invention, at a pet store or convenience store on the way to the destination of travel.

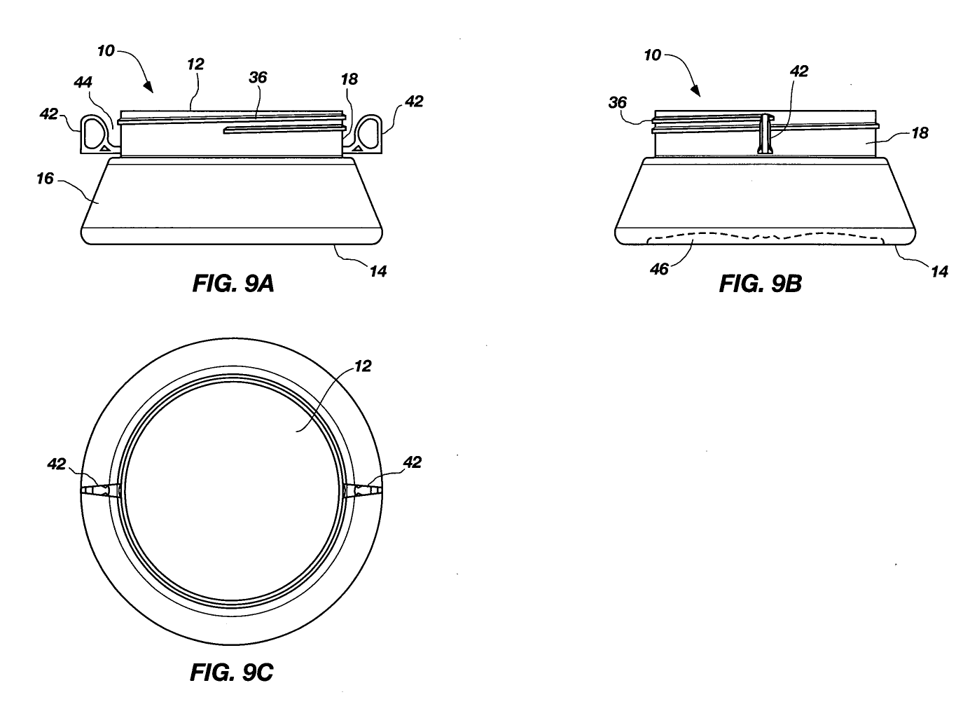

FIGS. 9A-9C illustrate another embodiment of the invention where handles 42 are formed on a neck portion 18 of the container 10. The neck portion 18 is configured with threads 36 at or near the top 12 of the container 10 to threadingly receive a threaded lid, such as the lid 38 shown in FIGS. 8A-8D. The handles 42 of the embodiment shown in FIGS. 9A-9C are located a distance from the top 12 of the container and are radially spaced from the neck portion 18 to provide a space 44 to accommodate the positioning of a lid 38 on the top 12 of the container.

Again, the container 10 of the present invention may be made from any suitable lightweight material to enable the container to be easily transportable. Plastics are particularly suitable, and especially those that are recyclable for the conservation of the environment. However, the container may be made from other materials as well, such as waterproof-treated paper or aluminum. The container 10 may be made in any color or may be clear.

The container 10 may be formed and manufactured by any known process. If made of plastic, the bowl may be formed by such known techniques as injection molding or stretch-blown injection molding. Other known processes, such as casting, are usable as well.

The portable, disposable container of the present invention may be adaptable for use in transporting, storing and serving food and water to any animal and/or pet and may be made in any size, shape or dimension that is suitable to that purpose, as long as the container is portable. Thus, reference herein to specific details of the configuration or structure of the invention is by way of example only and not by way of limitation.

What is claimed is:

1. A container for retaining water or food for an animal, comprising:
an open top having a circumferential dimension;
a closed bottom having a circumferential dimension;
an upstanding, continuous wall extending between said open top and said closed bottom; and
at least one handle;
wherein said container is portable, lightweight, disposable, reusable and recyclable.

2. The container of claim 1 wherein said circumferential dimension of said bottom that is greater than said circumferential dimension of said open top.

3. The container of claim 2 wherein said at least one handle is positioned on said upstanding, continuous wall.

4. The container of claim 1 further comprising a neck portion extending between said upstanding, continuous wall and said open top, and further comprising at least one handle positioned along said neck portion.

5. The container of claim 1 further comprising a lid for resealably closing said open top.

6. The container of claim 5 wherein said lid is affixed to said container.

7. The container of claim 5 wherein said bottom is configured to register against the lid of another container constructed in accordance with claim 1 to enable the stacking of one container upon the other.

8. The container of claim 1 wherein said bottom is configured to register against the top of another container constructed in accordance with claim 1 to enable the stacking of one container upon the other.

9. A pre-filled container of water or food for an animal, comprising:
an open top having a circumferential dimension sized to receive the muzzle, snout or beak of an animal, said open top being configured to receive a lid in sealing relation to the top;
a closed bottom having a circumferential dimension;
an upstanding, continuous side wall extending between said open top and said closed bottom;
a lid for resealably closing said open top; and
a quantum of water or food sealed within said container,
wherein said container is portable, lightweight, disposable and recyclable.

10. The pre-filled container of claim 9 wherein said circumferential dimension of said bottom is greater than said circumferential dimension of said open top.

11. The pre-filled container of claim 9 further comprising at least one handle secured to said container between said open top and bottom.

12. The pre-filled container of claim 9 wherein said lid is affixed to said container.

13. The pre-filled container of claim 9 wherein said bottom is configured to register against the lid of another pre-filled container constructed in accordance with claim 8 to enable the stacking of one pre-filled container upon the another.

14. The pre-filled container of claim 9 wherein said bottom is configured to register against the top of another pre-filled container constructed in accordance with claim 8 to enable the stacking of one pre-filled container upon the another.
